(19) United States
(12) Patent Application Publication
(10) Pub. No.: US 2010/0235359 A1
(43) Pub. Date: Sep. 16, 2010

(54) FILE RETRIEVAL METHOD AND DEVICE AND TIME STREAM FILE PROCESSOR

(75) Inventors: Zhengfang Li, Shenzhen (CN); Yingfeng Lv, Shenzhen (CN); Jiawei Luo, Shenzhen (CN)

Correspondence Address: PEARNE & GORDON LLP, 1801 EAST 9TH STREET, SUITE 1200, CLEVELAND, OH, 44114-3108, US

(73) Assignee: SHENZHEN MPR TECHNOLOGY CO., LTD., Shenzhen (CN)

(21) Appl. No.: 12/306,103

(22) PCT Filed: Nov. 27, 2007
(86) PCT No.: PCT/CN07/71131

§ 371 Date: Dec. 22, 2008

(30) Foreign Application Priority Data
Sep. 28, 2007 (CN) 200710123657.7

(51) Int. Cl. G06F 17/30

(52) U.S. Cl. 707/741; 707/822; 707/E17.002; 707/752; 707/E17.01

(57) ABSTRACT

A file retrieval method of a file allocation table (FAT) system is provided, which includes steps of: A: acquiring cluster numbers of all clusters of a file; B: sorting the cluster numbers to create a cluster number index table; and C: looking up the cluster number index table to obtain a cluster number of a file cluster to be retrieved, and acquiring a content of the file cluster to be retrieved from a physical storage address corresponding to the cluster number. A file retrieval device is further provided, which includes a central processing unit (CPU) and an address index storage unit. The address index storage unit stores a cluster number index table of sorted cluster numbers of all clusters of a file. The CPU is adapted to obtain a cluster number of a file cluster to be retrieved according to the cluster number index table during retrieving and acquire a content of the file cluster to be retrieved from a physical storage address corresponding to the cluster number. A time stream file processor is further provided. Therefore, a file retrieving speed is enhanced.

### BACKGROUND OF THE INVENTION

1. Field of the Invention

The present invention relates to a file retrieval method and a file retrieval device of a file allocation table (FAT) system and a time stream file processor.

2. Related Art

Currently, a file allocation table (FAT) file format has been widely used in nearly all storage devices.

The FAT is mainly classified into FAT16 (16-bit FAT) and FAT32 (32-bit FAT) according to binary bits thereof. The FAT16 is a highly compatible file system developed by Microsoft in early days, which is widely applied to personal computers, especially removable storage devices. The FAT16 records a cluster-chain structure of a data area on a disk using an FAT table. In an FAT file system, a disk space is partitioned into units according to a certain number of sectors. Such unit is called a cluster. In general, each sector has a capacity of 512 bytes in principle. One cluster has a capacity of 2n (n is an integer) sectors, for example, 512 B, 1 K, 2 K, 4 K, 8 K, 16 K, and 32 K, which is generally no larger than 32 K in practice. The reason why the disk space is partitioned in a unit of clusters rather than sectors lies in that, when the disk partition has a large capacity, if 512 B sectors are used for disk management, the items of the FAT table may be increased, which results in an increased consumption and a low efficiency of the file system when a large file is accessed.

The FAT table is a chain structure introduced by Microsoft for disk data (file) indexing and positioning in the FAT file system. If one disk is compared to one book, the FAT table may be considered as a table of contents in the book, and the clusters of the file may be considered as contents of the chapters. However, the indication manner of the FAT table is quite different from that of the table of contents in the book. In the FAT file system, the files are stored according to a cluster-chain data structure formulated by the FAT table.

When it intends to retrieve a file from the FAT file system, the file is retrieved in a directory structure first. The directory structure of the FAT file system may be considered as a tree oriented from the root to leaves. The term “oriented” means that any file (including a file folder) within the FAT partition needs to be addressed beginning from the root directory. It may be considered that, the entrance for the directory structure is the root directory.

Since the FAT file system partitions the disk space in a unit of clusters, the basic unit of the disk space occupies by the file data is cluster instead of byte. Even if a file only occupies one byte, the system allocates one cluster to the file. After a specific file is searched through using the directory structure, cluster data of the file needs to be specifically retrieved. However, data of the same file is not necessarily stored in a continuous area as a whole, but often divided into several segments and stored like a chain, which is referred to as a chain storage mode of files. In order to allocate the disk space to corresponding files orderly to enable the files to be read from corresponding addresses, the space of data areas is recorded by the FAT table. In order to achieve the chain storage of files, the file system must accurately record the clusters that have already been occupied by files; meanwhile, designate, in each current occupied cluster, a cluster number of the next cluster for storing the subsequent contents, and as for the last cluster, the file system further designates that there is no subsequent cluster, which are all stored in the FAT table.

TABLE 1

| Cluster No. | 1 | 2 | 3 | . . . | 11 | 12 | 13 | . . . | 65 | 66 | 67 | . . . | 86 | 87 | . . . | 99 |
|---|---|---|---|---|---|---|---|---|---|---|---|---|---|---|---|---|
| Corresponding | Directory | 3 | 4 | . . . | FF | 13 | 14 | . . . | FF | 67 | 68 | | FF | 00 | . . . | 00 |
| Data | | | | | | | | | | | | | | | | |

As shown in Table 1, the first cluster of a certain file designated in the directory entry is 2; the record in the FAT table for the cluster 2 is then found, in which 3 is registered therein, and thus it is determined that the next cluster is 3; and then, the record in the FAT table for the cluster 3 is found, in which 4 is registered thereon, . . . ; and till the cluster 11, it is found that the next one points to FF, i.e., that is the end. That is to say, if it intends to find out a disk physical data corresponding to the data of the last cluster in the file, all clusters must be searched sequentially from the very beginning of the file.

Table 1 shows cluster numbers arranged sequentially, which is actually a completely random storage process, and the numbers may be out of order. Referring to FIG. 1, it is assumed that a file includes contents A, B, C, D, E, and F. The physical storage address corresponding to each cluster number includes a data field and a pointer field. The data field stores data contents of the file, and the pointer field stores the next node in the chain storage mode, i.e., a cluster number corresponding to a physical storage address that stores the next cluster data of the file. As shown in FIG. 1, under a random storage condition, corresponding cluster numbers of the sequentially arranged contents of the file are 1, 6, 11, 8, 3, and 17.

The FAT16 file system has been briefly described above. The FAT32 has the same FAT data structure as the FAT16, but the difference there-between lies in that the binary bits for recording the cluster chain is extended to 32 in FAT32.

As described above, no matter for FAT16 or FAT32, when it intends to retrieve a file, it directly searches for the FAT table of the file. Due to the chain storage mode, when searching for contents of the last cluster, all clusters need to be traversed from the first cluster to the last cluster. The larger the file is, the longer the time is required when retrieving the last cluster.

### SUMMARY OF THE INVENTION

Accordingly, the present invention is directed to a file retrieval method, which is suitable for improving a retrieving speed of the data segments in the file.

The present invention is also directed to a file retrieval device and a time stream file processor.

In order to achieve the above objectives, the present invention adopts the following technical solutions.

A file retrieval method of a file allocation table (FAT) system, which includes the steps of:

A: acquiring cluster numbers of all clusters of a file;

B: sorting the cluster numbers to create a cluster number index table; and

C: looking up the cluster number index table to obtain a cluster number of a file cluster to be retrieved, and acquiring a content of the file cluster to be retrieved from a physical storage address corresponding to the cluster number.

The step C of looking up the cluster number index table is achieved by using a binary search algorithm.

The cluster number index table is created when the file is opened or created.

The file is a time stream file.

The time stream file is a video file or an audio file.

The file retrieval method further includes the steps of: when the time stream file is created, adding a segment index table into the time stream file; and during retrieving, determining a file cluster to be retrieved segment by segment according to the segment index table before looking up the cluster number index table.

The present invention further provides a file retrieval device of an FAT system, which includes a central processing unit (CPU) and an address index storage unit. The address index storage unit stores a cluster number index table of sorted cluster numbers of all clusters of a file. The CPU is used to obtain a cluster number of a file cluster to be retrieved according to the cluster number index table during retrieving and acquire a content of the file cluster to be retrieved from a physical storage address corresponding to the cluster number.

The file is a time stream file.

The address index storage unit further stores a segment index table of the time stream file for determining a cluster corresponding to each data segment in a file to be retrieved during retrieving.

The present invention provides a time stream file processor adapted to process a time stream file in an FAT system, which includes a CPU and an address index storage unit. The address index storage unit stores a cluster number index table of sorted cluster numbers of all clusters of a file. The CPU is used to obtain a cluster number of a file cluster to be retrieved according to the cluster number index table during retrieving and acquire a content of the file cluster to be retrieved from a physical storage address corresponding to the cluster number.

The present invention has the following beneficial effects. Since the cluster number index table of the file is created, there is no need to look up a chain structure FAT table when searching for a cluster data in the file. Instead, the cluster number of the file can be directly obtained through looking up the cluster number index table in which the cluster numbers are arranged in sequence, and thus the data of the file cluster to be retrieved can be acquired from a physical storage address corresponding to the cluster number. Therefore, the retrieving speed is improved, especially when the cluster data to be retrieved is sorted in the latter part in the chain storage mode.

### BRIEF DESCRIPTION OF THE DRAWINGS

The present invention will become more fully understood from the detailed description given herein below for illustration only, which thus is not limitative of the present invention, and wherein:

FIG. 1 is a structural view of a chain storage mode in the prior art;

FIG. 2 is a flow chart of a file retrieval method according to an embodiment of the present invention;

FIG. 3 is a structural view of a file retrieval device according to an embodiment of the present invention; and

FIG. 4 is a structural view of a time stream file processor according to an embodiment of the present invention.

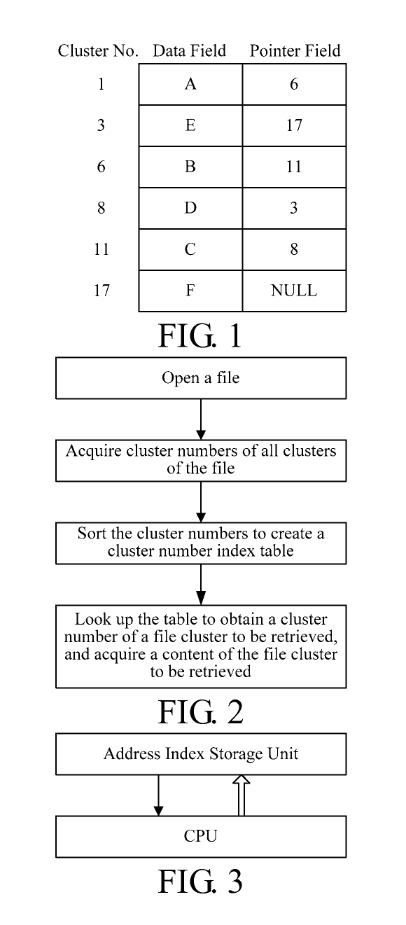

### DETAILED DESCRIPTION OF THE INVENTION

The present invention is described in further detail below with reference to specific embodiments and accompanying drawings.

Referring to FIG. 2, a file retrieval method according to an embodiment of the present invention includes the following steps:

1. Opening a file;

2. Acquiring cluster numbers of all clusters of the file;

3. Sorting the cluster numbers to create a cluster number index table; and

4. Looking up the cluster number index table to obtain a cluster number of a file cluster to be retrieved, and acquiring a content of the file cluster to be retrieved from a physical storage address corresponding to the cluster number.

In the present invention, during retrieving, a cluster number index table is created first. This table may be created when the file is opened as described in this embodiment, or when the file is created, i.e., stored into a magnetic disk. When the cluster number index table is created, a FAT table of the file is traversed first, so as to obtain cluster numbers of all clusters of the file. Afterwards, the cluster numbers are sequentially sorted, so as to create a cluster number index table of the cluster data of the file. When it intends to retrieve a certain cluster of the file, a cluster number of a file cluster to be retrieved is obtained through looking up the cluster number index table. The cluster number index table is looked up by using a binary search algorithm. After the cluster number is obtained, a content of the file cluster to be retrieved is acquired from a physical storage address corresponding to the cluster number, thereby completing the retrieval.

The file may be a time stream file, that is, a file with a time structure, such as a video file or an audio file. If the file is an organized video file or audio file, for example, the file may be formed by combining a plurality of video or audio segments together, the file may also be segmented, and accordingly a segment index table may be created for indicating a corresponding start sector and a corresponding end sector of each data segment. It should be noted that, the start sector and the end sector described herein refer to serial numbers of the corresponding sectors in the logical structure of the file, instead of logical sector numbers of the actual physical storage address of the file, and thus the start sector and the end sector herein are merely identifiers for indicating logical positions of the corresponding segment in the whole file. For example, a 1M file occupies 2000 sectors, which are numbered as 1-2000, and as for one data segment, the start sector thereof may be 3 and the end sector thereof may be 100. When it intends to retrieve a certain data segment, firstly, a start sector of the data segment is looked up from the segment index table, thus determining a file cluster to be retrieved. Then, a cluster number of the data segment is obtained according to the cluster number index table. Accordingly, a corresponding physical storage address is acquired, and a content of the file cluster is read and played back. The segment index table enables a user to find out the content to be retrieved more quickly. For example, an audio file may be used to record contents of a book. As one book generally includes a plurality of chapters, if each chapter is made into a separate audio file, a certain chapter to be played back can be quickly searched. However, a large number of chapters cause a large number of fragmented files, which hampers the file management. Therefore, these fragmented audio files may be integrated into one audio file, and meanwhile, a segment index table is created at a starting position of this audio file for indicating a start position and an end position of each chapter. In this manner, the user can quickly find out the chapter to be played back. Meanwhile, since one book only corresponds to one cluster number index table, the desired data can be quickly retrieved. Especially, in some applications that the hardware system does not support the storage of a large number of files in the same directory, the problem about the low retrieving speed can be effectively solved.

Experiments show that, under the experimental environments of a micro processing unit (MPU) with a dominant frequency of 24 M and an audio file with a capacity of about 100 M stored in NAND Flash in an MP3 format, when a data in a latter part of the file is retrieved, the time required for retrieving in the present invention can be reduced to about 0.3 seconds from 2-3 seconds of the prior art.

Referring to FIG. 3, a file retrieval device according to an embodiment of the present invention includes a CPU and an address index storage unit. The address index storage unit stores a cluster number index table of sorted cluster numbers of all clusters of a file. The CPU is used to obtain a cluster number of a file cluster to be retrieved according to the cluster number index table during retrieving and acquire a content of the file cluster to be retrieved from a physical storage address corresponding to the cluster number. The address index storage unit may further store a segment index table of a time stream file for quickly determining a cluster corresponding to each data segment in the file to be retrieved during retrieving.

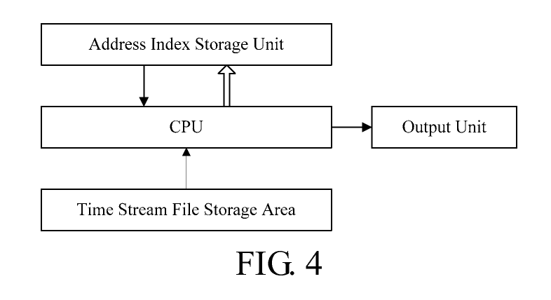

Referring to FIG. 4, a time stream file processor adapted to process a time stream file in a FAT system according to an embodiment of the present invention includes a CPU, an address index storage unit, a time stream file storage area, and an output unit. The address index storage unit stores a cluster number index table of sorted cluster numbers of all clusters of a file. The CPU is adapted to obtain a cluster number of a file cluster to be retrieved according to the cluster number index table during retrieving and acquire a content of the file cluster to be retrieved from a physical storage address corresponding to the cluster number. The time stream file storage area and the output unit are common techniques, the former may be a common storage device such as a FLASH, and the latter may be, for example, a liquid crystal display (LCD) module for video output or a loudspeaker for audio output. Likewise, the address index storage unit may further store a segment index table of the time stream file for quickly determining a cluster corresponding to each data segment in the file to be retrieved during retrieving.

The above time stream file processor may be an independent product for independently, for example, playing back or retrieving a time stream file such as a video or audio file, and may also be an improved product of an existing personal computer, MP3, MP4, reading pen, or the like. For example, an address index storage unit is additionally provided in the above products for storing a cluster number index table of sorted cluster numbers of all clusters of a file, and the CPUs of these products are responsible for corresponding processing functions. Alternatively, the file retrieval method according to the embodiment of the present invention is integrated into the CPUs of the above products as a firmware or through other manners, such that the CPUs retrieve files through the method of the present invention, thereby improving the retrieving speed.

The file retrieval method of the present invention is advantageous especially when repeatedly searching at different time points. For example, when playing back a video or audio file, operations such as fast-forward and rewind are often performed at different time points. Through the storage mode in the prior art, each time when these time points are retrieved, the searching operation needs be started from the start sector. With the present invention, the actual physical storage addresses of these time points can be quickly searched, thereby obtaining data there-from.

Experiments show that, in the prior art, the time required for the system program to search for the last sector in the file is directly proportional to the capacity of the file. The larger the file is, the longer the searching time is required. In contrast, with the present invention, the time required for the system program to search for the first sector is quite close to that required for searching for the last sector in the file, so that the retrieval of the cluster data of the file can be completed more quickly. The present invention is advantageous especially for time stream files.

The present invention has been described in further detail through the preferred embodiments, but the embodiments should not be considered as being limited to the above descriptions. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A file retrieval method of a file allocation table (FAT) system, comprising:
A: acquiring cluster numbers of all clusters of a file;
B: sorting the cluster numbers to create a cluster number index table; and
C: looking up the cluster number index table to obtain a cluster number of a file cluster to be retrieved, and acquiring a content of the file cluster to be retrieved from a physical storage address corresponding to the cluster number.

2. The file retrieval method according to claim 1, wherein the step C of looking up the cluster number index table is achieved by using a binary search algorithm.

3. The file retrieval method according to claim 1, wherein the cluster number index table is created when the file is opened or created.

4. The file retrieval method according to any one of claims 1-3, wherein the file is a time stream file.

5. The file retrieval method according to claim 4, wherein the time stream file is a video file or an audio file.

6. The file retrieval method according to claim 4, further comprising: when the time stream file is created, adding a segment index table into the time stream file; and during retrieving, determining a file cluster to be retrieved segment by segment according to the segment index table before looking up the cluster number index table.

7. A file retrieval device of a file allocation table (FAT) system, comprising: a central processing unit (CPU) and an address index storage unit, wherein the address index storage unit stores a cluster number index table of sorted cluster numbers of all clusters of a file, and the CPU is used to obtain a cluster number of a file cluster to be retrieved according to the cluster number index table during retrieving and acquire a content of the file cluster to be retrieved from a physical storage address corresponding to the cluster number.

8. The file retrieval device according to claim 7, wherein the file is a time stream file.

9. The file retrieval device according to claim 8, wherein the address index storage unit further stores a segment index table of the time stream file for determining a cluster corresponding to each data segment in a file to be retrieved during retrieving.

10. A time stream file processor, adapted to process a time stream file in a file allocation table (FAT) system, the time stream file processor comprising: a central processing unit (CPU) and an address index storage unit, wherein the address index storage unit stores a cluster number index table of sorted cluster numbers of all clusters of a file, and the CPU is used to obtain a cluster number of a file cluster to be retrieved according to the cluster number index table during retrieving and acquire a content of the file cluster to be retrieved from a physical storage address corresponding to the cluster number.
